(19) United States
(12) Patent Application Publication
(10) Pub. No.: US 2012/0093087 A1
(43) Pub. Date: Apr. 19, 2012

(54) Trail-Based Data Gathering Mechanism for Wireless Sensor Networks with Mobile Sinks

(75) Inventors: Canfeng Chen, Beijing (CN); Jian Ma, Beijing (CN); Baoxian Zhang, Beijing (CN)

(73) Assignee: NOKIA CORPORATION, Espoo (FI)

(21) Appl. No.: 13/378,321

(22) PCT Filed: Jun. 29, 2009
(86) PCT No.: PCT/IB2009/052816

§ 371 Date: Dec. 14, 2011

(51) Int. Cl. H04W 40/06

(52) U.S. Cl. 370/328

(57) ABSTRACT

A method, apparatus, and computer program product are provided for routing data packets through a wireless sensor network to a mobile sink in a relatively quick and efficient manner while utilizing low protocol overhead. Additionally, a method, apparatus, and computer program product are provided such that a sensor node within a wireless sensor network maintains sink information and routing information to facilitate efficient delivery of a data packet to a mobile sink within a wireless sensor network.

### TECHNICAL FIELD

Embodiments of the present invention relate generally to communication within a network and, more particularly, sending information to a mobile sink within a network.

### BACKGROUND

A wireless sensor network is a wireless network consisting of many small and typically inexpensive sensors that are spatially distributed over a potentially vast field to cooperate to measure real world phenomena, but also store, process, and transfer such information. Due to these attractive characteristics, sensor networks have been adopted in many civil and military applications such as environmental control, anti-intrusion, security management, and military battlefield surveillance among others.

It is widely accepted that wireless sensor networks have a “hotspot” issue in that all data packets have to go through those sensor nodes in the vicinity of static sink nodes. When sensor nodes in the vicinity of static sinks run out of their power, the network is partitioned. Wireless sensor networks with mobile sinks (mWSN) can effectively eliminate the “hotspot” issue as mobile sinks move within the network which helps balance the traffic load at the sensor nodes throughout the network.

Routing is a critical issue within a wireless sensor network for delivering packets from sensor nodes to a nearby mobile sink. Effective routing with low protocol overhead in mWSN is challenging as sinks move freely and unpredictably within the wireless sensor network. Inappropriate selection of a routing mechanism for data gathering in an mWSN could introduce a much higher level of protocol overhead which can degrade the performance of the mWSN. Although many mechanisms have been designed for wireless sensor networks, most of them are inappropriate for dynamic mobile wireless sensor networks.

A number of different routing mechanisms have been developed to handle delivery of data packets from sensor nodes to sinks within a wireless sensor network. Several of which are described herein.

“Flooding” is the most basic way to deliver a data packet to a sink. Specifically, to deliver a data packet, the source sensor floods the data packet across the entire network. Each node receives the packet and retransmits it further as long as it is not a duplicate data packet. Flooding is often used in network operations when no network state information is known. Flooding has high reliability in terms of packet delivery; however it causes extremely high protocol overhead or network traffic.

The “Random Walk” data packet delivery method begins when sensor node x sends a packet to a randomly selected sensor node neighbor. For example, if node x has f(x) neighbors, then the probability at which one of the neighbors is chosen is 1/f(x). This process continues until the packet reaches the destination or the data packet times out and is then discarded. Random walk is simple, localized and robust, but it causes a great deal of delay in the propagation of data through nodes in the network.

In the “Geographical Forwarding” data packet delivery method, the holder of a data packet can make a choice on the next hop for forwarding the packet to its intended destination by using the locations of itself, its neighbors and that of the destination. This approach is simple to implement; however its implementation requires the availability of location information of nodes, which can introduce extra cost for network deployment. Moreover, to make the location of mobile sinks available to sensor nodes for packet forwarding, a dynamic location service is needed in the network to provide such information to the sensors in the networks which can create much more proactive overhead.

The “Directed Diffusion” data packet delivery method builds a gradient-based forwarding structure for sensors to report their sensed data to sink. In directed diffusion, the gradient structure in a sensor network is established via periodic flooding of interests, initiated by a sink node. The advantage of directed diffusion and its variants is that it enables data to be delivered along the shortest paths; however directed diffusion is not suitable for mWSNs because sink mobility can cause established gradients to be invalid and will trigger gradient re-establishments. Frequent gradient re-establishment will generate extremely high protocol overhead.

“Data Gathering with controlled sink movement” is yet another data packet delivery method. In some existing networks, to optimize the network performance such as network lifetime or to ease the protocol design, controlled sink mobility is considered such that a sink moves along a predetermined optimized trajectory or path meeting certain criteria. With this method, often mobile sinks move toward sensor nodes with high residual energy to prolong the network lifetime. Alternatively, a mobile sink may be assumed to always jump along the edges of the network and is always situated at one of the sensor nodes in the network. Packets may be forwarded to the neighboring node last visited by the mobile sink; however the data packet delivery is based on controlled movement and the mobile sink is not free to move uncontrolled or in an unpredicted manner. Also, mechanisms of this delivery method must first know the position of sensor nodes such that a mobile sink can move towards a sensor node with a high energy or along an edge. Should a mobile sink move freely within a wireless sensor network employing this type of packet delivery method, broken routing paths would cause a high number of data packet losses when data packets are forwarded to broken paths.

Still another method of data packet delivery is using “Data Mules”. Data Mules are used to collect data from networks that are more sparse and typically require delay-tolerant applications. Data Mules can be vehicles, human, or animals outfitted with transceivers and they can move freely. The data mule can pick up data from sensors when in short range, buffer it, and drop off the data to wired access points when in close proximity. The advantage of this method is protocol simplicity and very low protocol overhead. When using data mules for data collection, there is no need for maintaining a multi-hop network structure. The primary disadvantage of data mules is the long delivery latency that could be hours or days.

Though the above routing mechanisms may handle delivery of packets from sensor nodes to sinks within a wireless sensor network, each has its deficiencies and the applicant has identified improvements that may reduce protocol overhead, decrease the time to deliver a packet, and/or increase efficiency of the sensor network.

### BRIEF SUMMARY

A method, apparatus, and computer program product are provided in accordance with exemplary embodiments of the present invention for routing data packets through a wireless sensor network to a mobile sink in a relatively quick and efficient manner while using low protocol overhead. Additionally, a method, apparatus, and computer program product are provided according to other embodiments of the present invention such that a sensor node within a wireless sensor network maintains sink information and routing information pertinent to efficient delivery of a data packet within a wireless sensor network.

Embodiments of the present invention are configured to deliver data packets from a source sensor node to a mobile sink in a wireless sensor network via multi-hop packet forwarding with relatively low protocol overhead.

In an exemplary embodiment, a method is provided to determine whether routing information is available at an apparatus regarding a mobile sink to which a prior message intended for receipt a mobile sink was directed. A current message may be transmitted based upon the routing information. The method may further determine whether timestamp information is available regarding prior receipt of a beacon message from a mobile sink and transmit the current message based upon the most recent timestamp information available. The method may also query other apparatuses in the vicinity to determine if other apparatuses have more recent timestamp information and the sensor node may transmit the current message based upon the most recent timestamp information available.

In a further exemplary embodiment, the beacon message may contain timestamp information and mobile sink identification information. When a beacon message is received, the method may write the timestamp information and the mobile sink identification information to a table. The method may further include in the table a timer that defines the time for which the beacon information is valid. Upon expiration of the timer, the beacon information may be removed from the table. If more recent beacon information is received, the more recent timestamp and mobile sink identification information may replace the older beacon message information.

In a still further exemplary embodiment of the present invention, the method may initiate a random walk data packet transfer method if no mobile sink information is available at the node or at any neighboring sensor nodes.

In another exemplary embodiment, an apparatus is provided which includes at least one processor and at least one memory including computer program code. In this embodiment, the at least one memory and the computer program code are configured to, with the at least one processor, cause the apparatus to determine whether routing information is available at a sensor node regarding a mobile sink to which a prior message intended for receipt a mobile sink was directed; and transmit a current message based upon the routing information if available. The apparatus may further determine whether timestamp information is available regarding prior receipt of a beacon message from a mobile sink and transmit the current message based upon the most recent timestamp information available. The apparatus may also query other sensor nodes in the vicinity to determine if other sensor nodes have more recent timestamp information and the sensor node may transmit the current message based upon the most recent timestamp information available.

In a further exemplary embodiment, the beacon message may contain timestamp information and mobile sink identification information. When a beacon message is received at the apparatus, the apparatus may write the timestamp information and the mobile sink identification information to a table. The apparatus may further include in the table a timer that defines the time for which the beacon information is valid. Upon expiration of the timer, the beacon information may be removed from the table. If more recent beacon information is received by the apparatus, the more recent timestamp and mobile sink identification information may replace the older beacon message information.

In a still further exemplary embodiment of the present invention, the apparatus may initiate a random walk data packet transfer method if no mobile sink information is available at the apparatus or at any neighboring apparatuses.

The mobile sink of one embodiment is a mobile phone that further includes user interface circuitry and user interface software configured to facilitate user control of at least some functions of the mobile phone through use of a display and configured to display at least a portion of a user interface of the mobile phone. In accordance with this embodiment, the display and display circuitry are configured to facilitate user control of at least some functions of the mobile phone.

In another exemplary embodiment, a computer program product is provided that includes at least one computer-readable storage medium having computer-readable program instructions stored therein. In this embodiment, the computer-readable program instructions are configured to cause an apparatus to at least determine whether routing information is available at a sensor node regarding a mobile sink to which a prior message intended for receipt a mobile sink was directed; and transmit a current message based upon the routing information if available. The apparatus may also be caused to further determine whether timestamp information is available regarding prior receipt of a beacon message from a mobile sink and transmit the current message based upon the most recent timestamp information available. The apparatus may also be caused to query other sensor nodes in the vicinity to determine if other sensor nodes have more recent timestamp information and the sensor node may transmit the current message based upon the most recent timestamp information available.

In a further exemplary embodiment, the beacon message may contain timestamp information and mobile sink identification information. When a beacon message is received, the program instructions may cause the apparatus may write the timestamp information and the mobile sink identification information to a table. The program instructions may also cause the apparatus to further include in the table a timer that defines the time for which the beacon information is valid. Upon expiration of the timer, the beacon information may be removed from the table. If more recent beacon information is received, the more recent timestamp and mobile sink identification information may replace the older beacon message information.

In a still further exemplary embodiment of the present invention, the program instructions may cause the apparatus to initiate a random walk data packet transfer method if no mobile sink information is available at the apparatus or at any neighboring apparatuses.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is an illustration of a wireless sensor network according to one exemplary embodiment of the present invention;

FIG. 2 is an illustration of a sensor node of a wireless sensor network according to an exemplary embodiment of the present invention;

FIG. 3 is an illustration of a mobile sink according to an exemplary embodiment of the present invention;

FIG. 4 is an illustration of a wireless sensor network using the flooding method of data packet delivery;

FIG. 5 is an illustration of a wireless sensor network with a mobile sink generating a trail according to an exemplary embodiment of the present invention;

FIG. 6 is an illustration of a wireless sensor network using trail-based data packet transmission according to an exemplary embodiment of the present invention;

FIG. 7 is an illustration of a wireless sensor network using trail-based data packet transmission according to another exemplary embodiment of the present invention;

FIG. 8 is a flowchart illustrating sensor node functions when a sensor node receives a query message according to an exemplary embodiment of the present invention;

FIG. 9 is a flowchart illustrating routing table learning according to an exemplary embodiment of the present invention;

FIG. 10 is a flowchart illustrating the forwarding of a data packet from a sensor node according to an exemplary embodiment of the present invention; and

FIG. 11 is a flowchart illustrating the procedure for initiating trail-broadening according to an exemplary embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

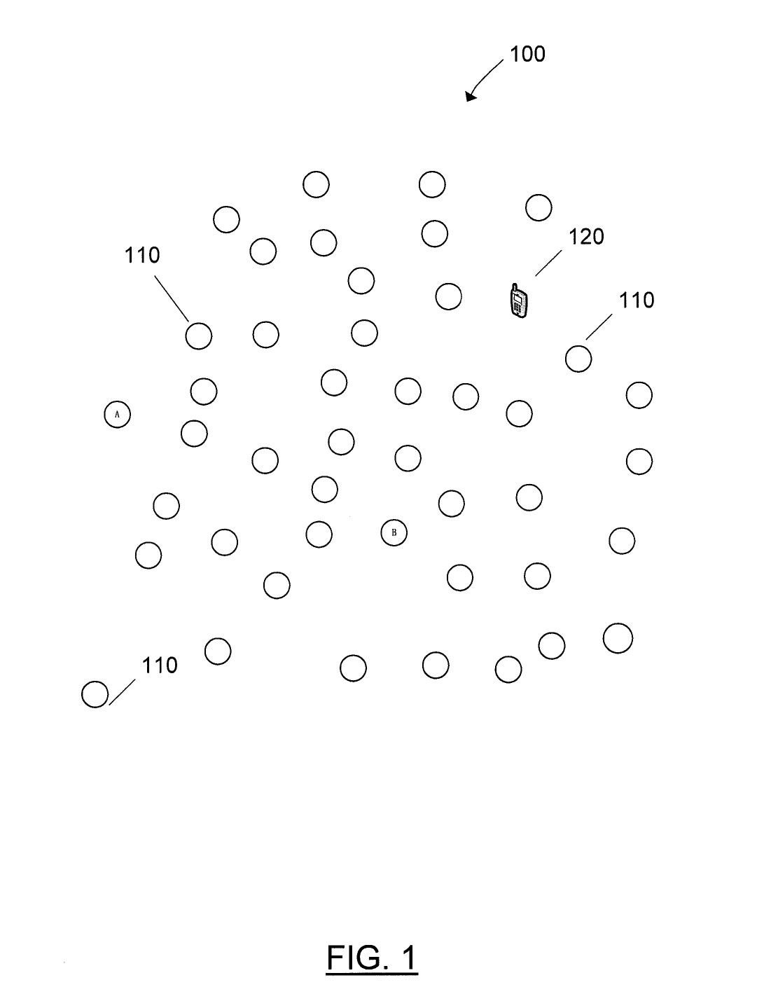

A wireless sensor network 100 may consist of many small sensor nodes as illustrated in FIG. 1 which should be understood to be an example of a broad view of certain elements of a system that may incorporate embodiments of the present invention and not an all inclusive or detailed view of a wireless sensor network. The sensor nodes 110 may be capable of not only measuring real world phenomena, but also storing, processing and transferring this data. The wireless sensor nodes 110 may be arranged in a spatial relationship that allows each sensor node to be in wireless communication with at least one other sensor node 110. In a wireless sensor network, sensed data or information usually needs to be reported from source sensor nodes to users or network administrators via sink nodes. A mobile sink 120 may be a device that may be used to acquire information within the sensor network and it may move freely and unpredictably within the wireless sensor network. A wireless mobile sink 120 may be desirable in a wireless sensor network as static sink nodes tend to generate a “hotspot” issue. A hotspot issue occurs when all of the data packets have to travel through sensor nodes that are in the immediate vicinity of a stationary, static sink node to reach the sink node. Since the sensor nodes in the immediate vicinity of the static sink node are heavily used by data traffic, they tend to run out of power faster than other sensor nodes in the wireless sensor network and when they lose power, they partition the network. Wireless sensor networks with mobile sinks (mWSN) can effectively eliminate the above hotspot issue as mobile sinks move in the network, which helps to balance the traffic load distribution in the network.

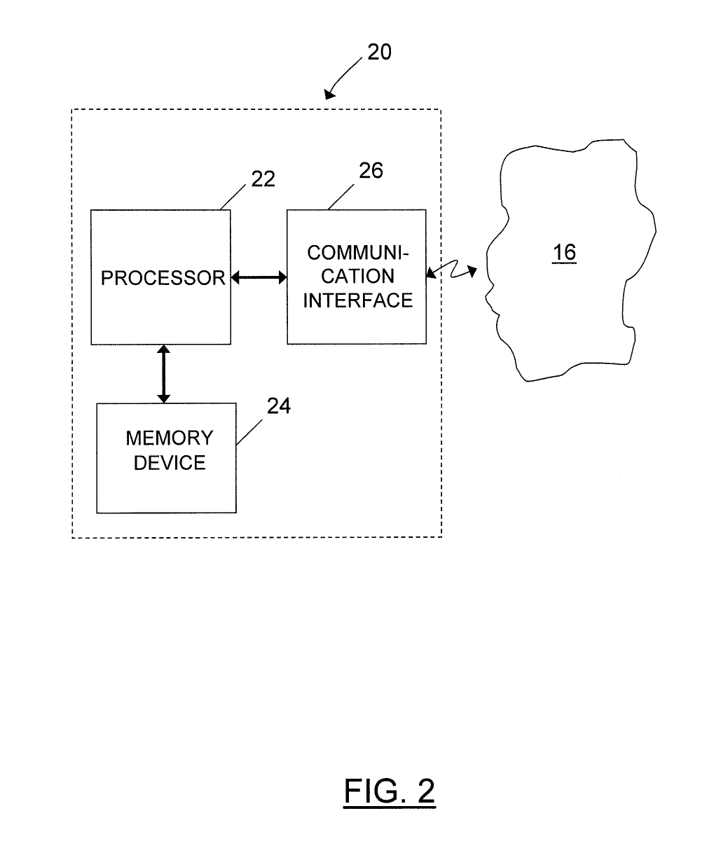

As illustrated in FIG. 2, an exemplary sensor node 20 may comprise a processor 22 and a memory device 24 operating in cooperation with a communications interface 26. The processor 22 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 22 may be representative of a plurality of processors, or one or more multiple core processors, operating in concert. Further, the processor 22 may be comprised of a plurality of transistors, logic gates, a clock (e.g., oscillator), and the like to facilitate performance of the functionality described herein. The processor 22 may, but need not, include one or more accompanying digital signal processors. In some example embodiments, the processor 22 is configured to execute instructions stored in the memory device 24 or instructions otherwise accessible to the processor 22. The processor 22 may be configured to operate such that the processor causes the apparatus 20 to perform various functionalities described herein. Whether configured as hardware or via instructions stored on a computer-readable storage medium, or by a combination thereof, the processor 22 may be an entity capable of performing operations according to embodiments of the present invention while configured accordingly. Thus, in example embodiments where the processor 22 is embodied as an ASIC, FPGA, or the like, the processor 22 is specifically configured hardware for conducting the operations described herein. Alternatively, in example embodiments where the processor 22 is embodied as an executor of instructions stored on a computer-readable storage medium, the instructions specifically configure the processor 22 to perform the algorithms and operations described herein. In some example embodiments, the processor 22 is a processor of a specific device (e.g., a sensor node) configured for employing example embodiments of the present invention by further configuration of the processor 22 via executed instructions for performing the algorithms and operations described herein.

The memory device 24 may be one or more computer-readable storage media that may include volatile and/or non-volatile memory. In some example embodiments, the memory device 24 includes Random Access Memory (RAM) including dynamic and/or static RAM, on-chip or off-chip cache memory, and/or the like. Further, memory device 24 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 24 may include a cache area for temporary storage of data. In this regard, some or all of memory device 24 may be included within the processor 22.

Further, the memory device 24 may be configured to store information, data, applications, computer-readable program code instructions, or the like for enabling the processor 22 and the example apparatus 20 to carry out various functions in accordance with example embodiments of the present invention described herein. For example, the memory device 24 could be configured to buffer input data for processing by the processor 22. Additionally, or alternatively, the memory device 24 may be configured to store instructions for execution by the processor 22.

The communication interface 26 may be any device or means embodied in either hardware, a computer program product, or a combination of hardware and a computer program product that is configured to receive and/or transmit data from/to a network 16 and/or any other device or module, such as a base station, access point or the like, in communication with the example apparatus 20. Processor 22 may also be configured to facilitate communications via the communications interface by, for example, controlling hardware included within the communications interface 26. In this regard, the communication interface 26 may include, for example, one or more antennas, a transmitter, a receiver, a transceiver and/or supporting hardware, including a processor for enabling communications with network 16. Via the communication interface 26 and the network 16, the example apparatus 20 may communicate with various other network entities in a device-to-device fashion and/or via indirect communications via a base station, access point, server, gateway, router, or the like.

The communications interface 26 may be configured to provide for communications in accordance with any wired or wireless communication standard. The communications interface 26 may be configured to support communications in multiple antenna environments, such as multiple input multiple output (MIMO) environments. Further, the communications interface 26 may be configured to support orthogonal frequency division multiplexed (OFDM) signaling. In some example embodiments, the communications interface 26 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA200, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 26 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 26 may also be configured to support communications at the network layer, possibly via Internet Protocol (IP).

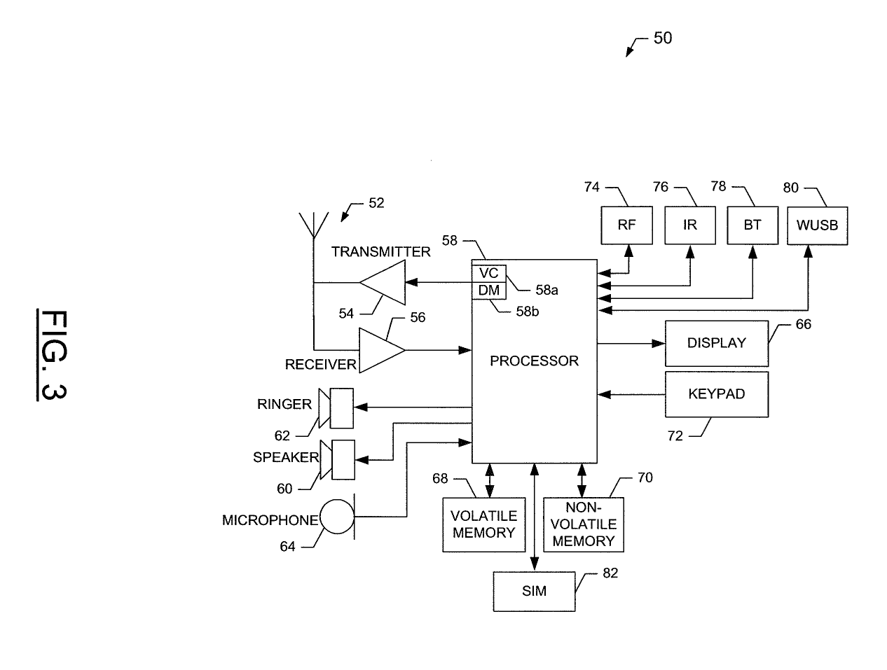

The mobile sink 50 may be configured in various manners, but in one embodiment is a mobile device such as laptop computer, mobile terminal, mobile computer, mobile phone, mobile communication device, game device, digital camera/camcorder, audit/video player, television device, radio receiver, digital video recorder, positioning device, any combination thereof, and/or the like. In an exemplary embodiment, the mobile sink 50 is embodied as a mobile terminal, such as that illustrated in FIG. 3.

In this regard, FIG. 3 illustrates a block diagram of a mobile terminal representative of one embodiment of a mobile sink 50 in accordance with embodiments of the present invention. It should be understood, however, that the mobile terminal illustrated and hereinafter described is merely illustrative of one type of mobile sink 50 that may implement and/or benefit from embodiments of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As illustrated in FIG. 3, the mobile sink 50 may include an antenna 52 (or multiple antennas 12) in communication with a transmitter 54 and a receiver 56. The mobile sink may also include one or more processors 58 that provides signals to and receives signals from the transmitter and receiver, respectively. These signals may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile sink may be capable of operating with one or more air interface standards, communication protocols, modulation types, access types, and/or the like. More particularly, the mobile sink may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile sink may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile sink may be capable of operating in accordance with 2.5G wireless communication protocols General Packet Radio Service (GPRS), Enhanced Data GSM Environment (EDGE), and/or the like. Further, for example, the mobile sink may be capable of operating in accordance with 3G wireless communication protocols such as Universal Mobile Telecommunications System (UMTS), Code Division Multiple Access 200 (CDMA200), Wideband Code Division Multiple Access (WCDMA), Time Division-Synchronous Code Division Multiple Access (TD-SCDMA), and/or the like. The mobile sink may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile sink may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile sinks may also benefit from embodiments of this invention, as should dual or higher mode phones (e.g., digital/analog or TDMA/CDMA/analog phones). Additionally, the mobile sink 50 may be capable of operating according to Wireless Fidelity (Wi-Fi) or Worldwide Interoperability for Microwave Access (WiMAX) protocols.

It is understood that the processor 58 may comprise circuitry for implementing audio/video and logic functions of the mobile sink 50. For example, the processor 58 may comprise a digital signal processor device, a microprocessor device, processing circuitry, an analog-to-digital converter, a digital-to-analog converter, and/or the like. Control and signal processing functions of the mobile sink may be allocated between these devices according to their respective capabilities. The processor may additionally comprise an internal voice coder (VC) 58a, an internal data modem (DM) 58b, and/or the like. Further, the processor may comprise functionality to operate one or more software programs, which may be stored in memory. For example, the processor 58 may be capable of operating a connectivity program, such as a web browser. The connectivity program may allow the mobile sink 50 to transmit and receive web content, such as location-based content, according to a protocol, such as Wireless Application Protocol (WAP), hypertext transfer protocol (HTTP), and/or the like. The mobile sink 50 may be capable of using a Transmission Control Protocol/Internet Protocol (TCP/IP) to transmit and receive web content across the internet or other networks.

The mobile sink 50 may also comprise a user interface including, for example, an earphone or speaker 60, a ringer 62, a microphone 64, a display 66, a user input interface, and/or the like, which may be operationally coupled to the processor 58. In this regard, the processor 58 may comprise user interface circuitry configured to control at least some functions of one or elements of the user interface, such as, for example, the speaker 60, the ringer 62, the microphone 64, the display 66, and/or the like. The processor 58 and/or user interface circuitry comprising the processor 58 may be configured to control one or more functions of one or more elements of the user interface through computer program instructions (e.g., software and/or firmware, such as user interface software) stored on a memory accessible to the processor 58 (e.g., volatile memory 68, non-volatile memory 70, and/or the like). Although not shown, the mobile sink may comprise a battery for powering various circuits related to the mobile sink, for example, a circuit to provide mechanical vibration as a detectable output. The user input interface may comprise devices allowing the mobile sink to receive data, such as a keypad 72, a touch display (not shown), a joystick (not shown), and/or other input device. In embodiments including a keypad, the keypad may comprise numeric (0-9) and related keys (#, *), and/or other keys for operating the mobile sink. In embodiments that include a display, the display and display circuitry may be configured to facilitate user control of at least some functions of the mobile sink.

As shown in FIG. 3, the mobile sink 50 may also include one or more means for sharing and/or obtaining data. For example, the mobile sink may comprise a short-range radio frequency (RF) transceiver and/or interrogator 74 so data may be shared with and/or obtained from electronic devices in accordance with RF techniques such as the sensor nodes 20. The mobile sink may comprise other short-range transceivers, such as, for example, an infrared (IR) transceiver 76, a Bluetooth™ (BT) transceiver 78 operating using Bluetooth™ brand wireless technology developed by the Bluetooth™ Special Interest Group, a wireless universal serial bus (USB) transceiver 80 and/or the like. The Bluetooth™ transceiver 78 may be capable of operating according to ultra-low power Bluetooth™ technology (e.g., Wibree™) radio standards. In this regard, the mobile sink 50 and, in particular, the short-range transceiver may be capable of transmitting data to and/or receiving data from electronic devices within a proximity of the mobile sink, such as sensor nodes 20 within 10 meters, for example. Although not shown, the mobile sink may be capable of transmitting and/or receiving data from electronic devices according to various wireless networking techniques, including Wireless Fidelity (Wi-Fi), WLAN techniques such as IEEE 802.11 techniques, IEEE 802.16 techniques, and/or the like.

The mobile sink 50 may comprise memory, such as a subscriber identity module (SIM) 82, a removable user identity module (R-UIM), and/or the like, which may store information elements related to a mobile subscriber. In addition to the SIM, the mobile sink may comprise other removable and/or fixed memory. The mobile sink 50 may include volatile memory 68 and/or non-volatile memory 70. For example, volatile memory 68 may include Random Access Memory (RAM) including dynamic and/or static RAM, on-chip or off-chip cache memory, and/or the like. Non-volatile memory 70, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 68, non-volatile memory 70 may include a cache area for temporary storage of data. The memories may store one or more software programs, instructions, pieces of information, data, and/or the like which may be used by the mobile sink for performing functions of the mobile sink. For example, the memories may comprise an identifier, such as an international mobile equipment identification (IMEI) code, capable of uniquely identifying the mobile sink 50.

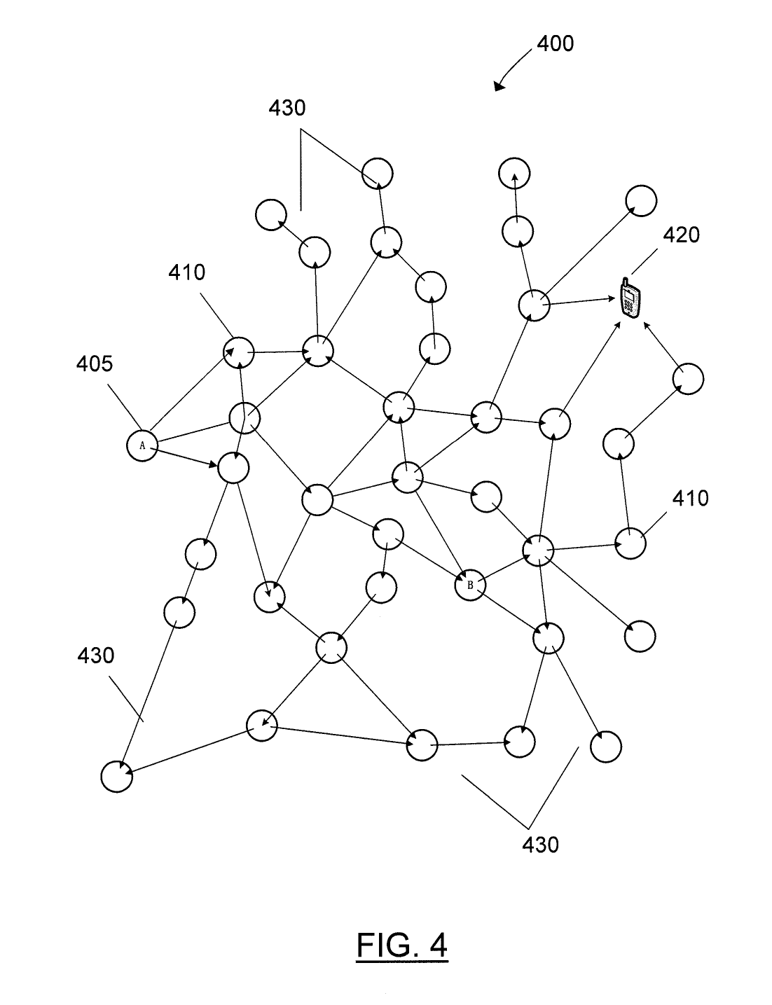

As previously discussed, there are a number of methods for transmitting a data packet within a wireless sensor network. FIG. 4 illustrates a method of transmitting a data packet to a mobile sink 420 within a wireless sensor network 400. This method, commonly known as “flooding” transmits the data packet from the originating sensor node 405 across the entire network 400 to reach the mobile sink 420. Each sensor node 410 receives the packet and retransmits the packet as long as it is not a duplicate packet. Flooding is often used in network operations when no network state information is known. While flooding has a high reliability for packet delivery to the mobile sink, it causes extremely high protocol overhead due to the volume of traffic within the network. This traffic is represented by the transmission lines 430.

Random walk is an alternative method for transmitting a data packet to a mobile sink within a wireless sensor network. In a random walk style of data transfer, a sensor node (node X) sends out a data packet to a randomly chosen neighboring sensor node (node Y) which, in turn, sends out a data packet to a randomly chosen neighboring sensor node (node Z) and so on until the data packet reaches the destination or the data packet times out and is discarded. Random walk randomly propagates a data packet throughout the network and it is a simple, localized data packet delivery system; however it may at least sometimes cause a large delay in delivering the data packet to the destination and higher protocol overhead than embodiments of the present invention.

Exemplary embodiments of the present invention are configured to deliver sensed data from source sensors to a mobile sink in an mWSN via multi-hop packet forwarding with relatively low protocol overhead. Each mobile sink may move freely and unpredictably. The term “hop” as used herein refers to data being transmitted from one sensor node to another sensor node or “hopping” from one sensor node to another. In embodiments of the present invention, the wireless sensor nodes are efficiently used to traffic data within the wireless sensor network such that data is delivered quickly while using a relatively few sensor nodes resulting in less traffic or protocol overhead.

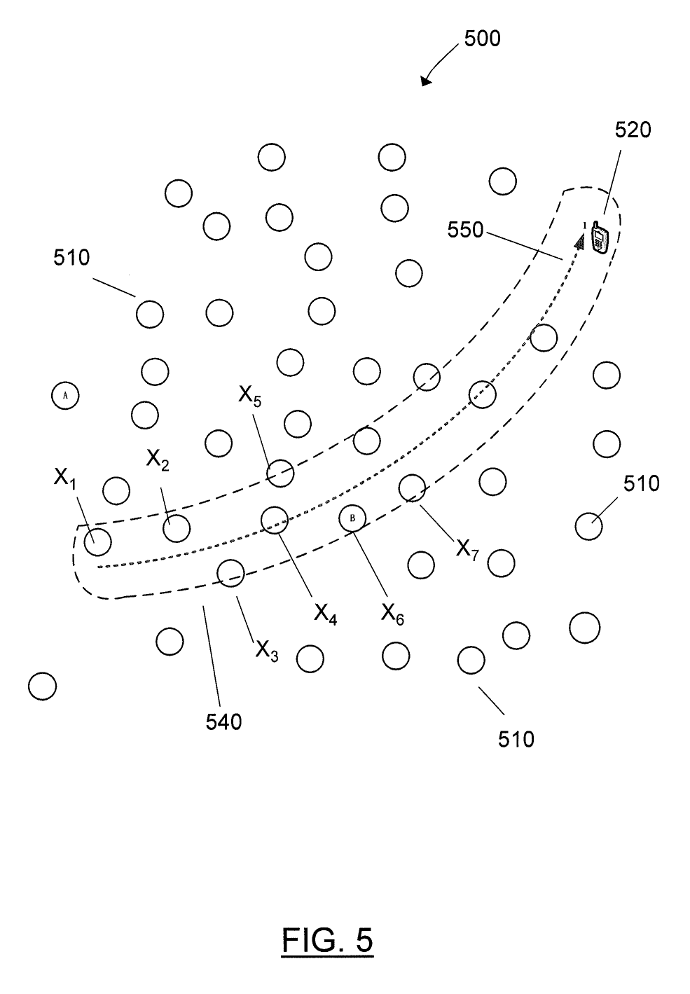

An exemplary embodiment of the present invention may allow a mobile sink 520 (one example of which is shown in FIG. 3) to generate a trail 540 when moving through a wireless sensor network 500 along a path 550 as illustrated in FIG. 5. In such an embodiment, a mobile sink 520 moving within a wireless sensor network 500 may be configured to periodically broadcast beacon messages to neighboring sensor nodes 510 (one example of which is shown in FIG. 2). The interval between the consecutively issued beacon messages may be affected by the velocity of the mobile sink. If the mobile sink is moving faster, beacon messages may occur more frequently with a shorter interval between consecutive beacon messages. The beacon messages may, for example, be broadcast by the transmitter 52, or other short-range transceivers, such as, for example, a Radio Frequency (RF) transceiver 74, an infrared (IR) transceiver 76, a Bluetooth™ (BT) transceiver 78 operating using Bluetooth™ brand wireless technology developed by the Bluetooth™ Special Interest Group, a wireless universal serial bus (USB) transceiver 80 and/or the like as shown in FIG. 3. If the mobile sink 520 is stationary or moving very slowly, the beacon messages may occur less frequently with a longer interval between consecutive beacon messages. The interval between consecutively issued beacon messages may also be tuned based on specific network deployment. For example, when the communication range of nodes 510 is 20 meters, the interval between consecutive beacon messages may be set to three seconds when the mobile sink moves at a speed of two meters per second. Should the speed be increased to 10 meters per second, the interval between beacons may be reduced to a half second. If the communication range of nodes 510 is greater than 20 meters, the interval between consecutive beacons may be increased. This beacon message that is broadcast may include the mobile sink ID and a timestamp that records when the beacon message was composed, among other possible information. The beacon message broadcast by the mobile sink 50 may be received at the sensor node 20 by the communication interface 26 as illustrated in FIG. 2, entered in to a table by the processor 22, and stored in the memory device 24.

In the above embodiment, each sensor node may be configured to record the beacon message information in a sink table. For example, sensor node X creates or updates its sink table upon the receipt of a beacon message issued by a sink (i.e., sink u). Specifically, upon receipt of a beacon message, the following two cases may be possible: First, if sensor node X has no record for any sink, then sensor node X creates an entry in its sink table with the mobile sink ID, the timestamp, and a timer that specifies the duration of how long the sink ID and timestamp are valid; Second, if the sensor node X has a sink record, then the sink record is updated with the new sink ID, timestamp, and the timer that specifies the duration of how long the sink ID and timestamp are valid is reset. It should be noted that the timer associated with the sink record should generally be much longer than the interval between consecutive beacon messages. When the timer associated with the sink record expires, the sensor node X may remove the sink record from its memory. The aforementioned operation may leave a sink record at each sensor node that a mobile sink visits along a trail. The visited sensor nodes will consecutively form a sink trail, which may be used for later packet forwarding. For a sensor node, the sink table that contains the sink record may typically contain at most one entry at any given time such that only the most recent sink that has visited the sensor node is recorded in the sink table.

Referring back to FIG. 5, the mobile sink 520 passes through the wireless sensor network 500 and generates a sink trail 540 as it moves within the network. The sink records for the sensor nodes Xᵢ in one exemplary embodiment are shown in Table 1 below. It should be noted that not all sensor nodes in the sink path 540 are represented by Table 1; however, every sensor node along the path 540 would have a record in the sink table. Each sensor node Xᵢ has its own sink record including the Sink ID, Timestamp, and the Timer. The sink record for each node is maintained at the respective node. Typically only one sink record is maintained at a sensor node at any given time.

TABLE 1

| Node | Sink ID | Timestamp | Timer |
|---|---|---|---|
| X₁ | 00001 | 8:31:06 AM | 3:55 |
| X₂ | 00001 | 8:31:21 AM | 4:10 |
| X₃ | 00001 | 8:31:31 AM | 4:20 |
| X₄ | 00001 | 8:31:46 AM | 4:35 |
| X₅ | 00001 | 8:31:51 AM | 4:40 |
| X₆ | 00001 | 8:32:06 AM | 4:55 |
| X₇ | 00001 | 8:32:11 AM | 5:00 |

Sensor nodes may also collaborate to forward data packets along a path of sensor nodes to a nearby mobile sink quickly by using a second table called a routing table, a respective one of which may be maintained by each sensor node. While the sink table records whether the sensor node has recently witnessed a mobile sink's passing by and when, the routing table contains the next-hop information that directs a sensor node where to send a data packet quickly, without querying other sensor nodes as is required when using the sink table. The routing table is generated by a sensor node based on feedback received from neighboring sensor nodes while they are receiving or forwarding data packets, as further outlined below. The routing table may be generated by the processor 22 of FIG. 2 and stored in the memory device 24, such that when a data packet is received at the sensor node 20 communication interface 26, the routing information is retrieved from the memory device 24 by the processor 22 in order to direct the data packet to the appropriate sensor node.

The sink table may be used by a sensor node to look up mobile sink related information when a data packet is received. The sink table may be stored in the memory device 24 of FIG. 2, for example and accessed by the processor 22. If sensor node x receives a data packet, it may initially reference its sink table. If there is a valid sink record in the sink table (i.e., an unexpired sink ID and sink timestamp), sensor node x may send out a local query message to its neighboring nodes. The query message may contain the identifier of the querying node (node x in this case), a timestamp copied from the local sink record, and a TTL option with a value of one. After sending out the query, sensor node x may wait for a reply message, if possible. This query-reply exchange immediately before forwarding a data packet may avoid proactive overhead for trail management and it may largely reduce the total protocol overhead for low or medium-loaded sensor networks.

TABLE 2 below illustrates an exemplary embodiment of the Procedure QueryProcessing that shows the procedures for a node (node y, where y does not equal x) to process a received local query message.

TABLE 2
// rand(u,v) returns a value uniformly distributed between u and v.
Procedure QueryProcessing(x)

| | |
|---|---|
| 1. | If node x is a sink node, then |

| | |
|---|---|
| 2. | start a timer t_{reply} such that t_{reply}:=rand(0,T1) |

| | |
|---|---|
| 3. | else // x is a sensor node |

| | |
|---|---|
| 4. | if x has an entry with fresher time stamp than that in the |

received query message, then

| | |
|---|---|
| 5. | start a timer t_{reply} such that t_{reply}:=rand(T1,T2) |

| | |
|---|---|
| 6. | else |

| | |
|---|---|
| 7. | discard the query message |

| | |
|---|---|
| 8. | end if |

| | |
|---|---|
| 9. | endif |

end queryProcessing

The processing of the sink table information and the routing information, which may be stored in the memory device 24 of FIG. 2, may be performed by the processor 22, and the communicating of query requests and responses may be performed by the communication interface 26 of the sensor node 20. In this embodiment, if node y is a sink node, it will initiate a short random back off timer for sending back a reply to the querying node, which is randomly chosen in the range of [0, T1]. For example, T1 can be set to 50 milliseconds. If node y is a sensor node with a more recent timestamp for any sink record as compared to that in the querying node, it may set a timer (denoted by t_{reply}) with a duration chosen in the range of [T1,T2] for sending back a reply. T2 is a network parameter that may be set to, for example 100 milliseconds. Emax denotes the maximum nodal energy and node y's residual energy is denoted by Ey. t_{reply} may be randomly chosen in [T1,T2] or based on the criterion in either (a) or (b) as shown below:

(a) the residual energy of node y, such that:

t_{reply}=rand[T1,T1+(T2−T1)*Ey/Emax]

(b) the difference between the time stamp recorded at y and that at x, denoted by Dy (Dy>0). Dy is an integer and is measured in the number of intervals of beacons issued by a sink. For case (a), a node y with larger residual energy should generally choose a smaller timer, and for case (b), a node y with larger Dy should generally respond first, which can help reduce the hop distance for end-to-end packet delivery, such that:

t_{reply}=rand[T1,T1+(T2−T1)*1/Dy]

In this embodiment, the above selection of timer duration is to enable a sink node to reply before any sensor node if possible. The randomness in the timer setting is to avoid or at least suppress collisions in the reply transmissions. When the sendReply timer expires (illustrated below in TABLE 3) and no neighboring node has sent a reply message, node y may send a reply message back to node x. If node x overhears a reply message in a given period of time, it will forward the packet to the sender of the reply message.

TABLE 3
Procedure sendReply( )
/* triggered when timer t_{reply} expires */

| | |
|---|---|
| 1. | if the current node has not overheard any reply that has been sent |
| | regarding the current local query then |

| | |
|---|---|
| 2. | reply.time_stamp := The time stamp |
| 3. | send a reply back to the querying node with the time stamp in |

end sendReply

If a reply is not received by the sensor node x that is trying to determine where to send the data packet next, sensor node x may initiate a random walk process for packet forwarding. Sensor node x of this embodiment would randomly select a node from its neighbor list and then send the data packet to the selected node. Each data packet may have a TTL option which records the longest path that the data packet is allowed to go. At each hop (from one sensor node to another), the TTL value may be decreased by one. Once the TTL value reaches zero, the packet will be dropped. This ensures a data packet will not remain in the network in an infinite cycle if a sink is not available within the network.

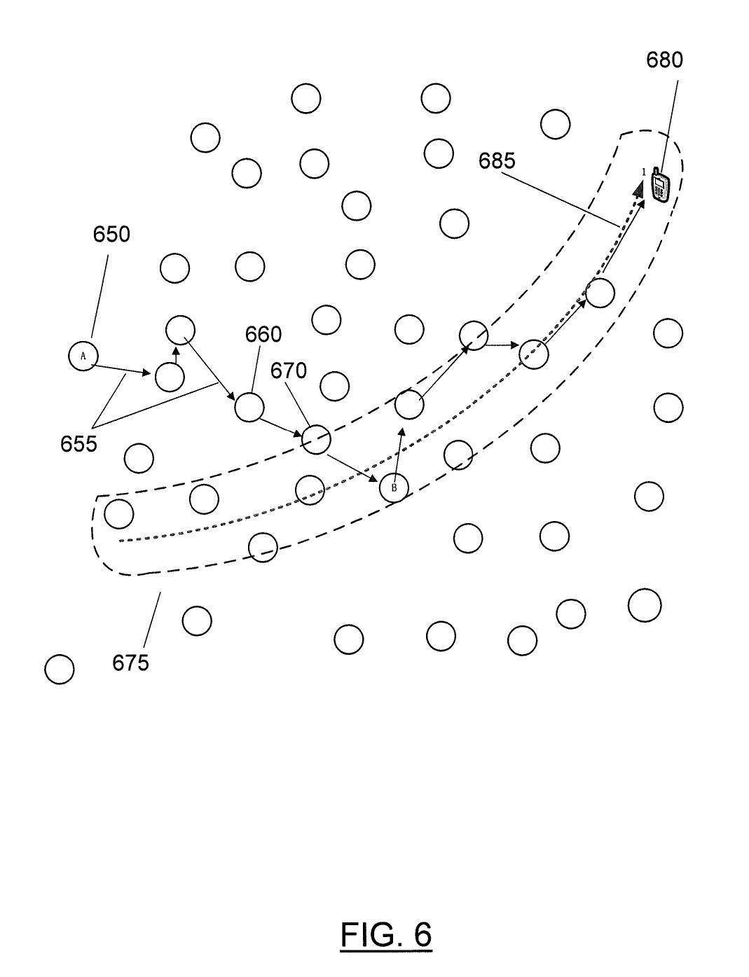

FIG. 6 illustrates an exemplary embodiment of the present invention where a data packet is initiated at sensor node 650 whereupon sensor node 650 begins a random walk sequence since it has no sink record or routing record. The data packet travels along the path 655. The random walk continues at sensor node 660 as no sink record or routing record is available. Once the data packet reaches sensor node 670, it ceases the random walk sequence and begins the trail-based packet transfer sequence since sensor node 670 has at least sink record information. The data packet travels efficiently along the trail 675 that is generated by the path 685 of the mobile sink 680. The data packet is advanced along the trail by the trail-based data and reaches the mobile sink 680.

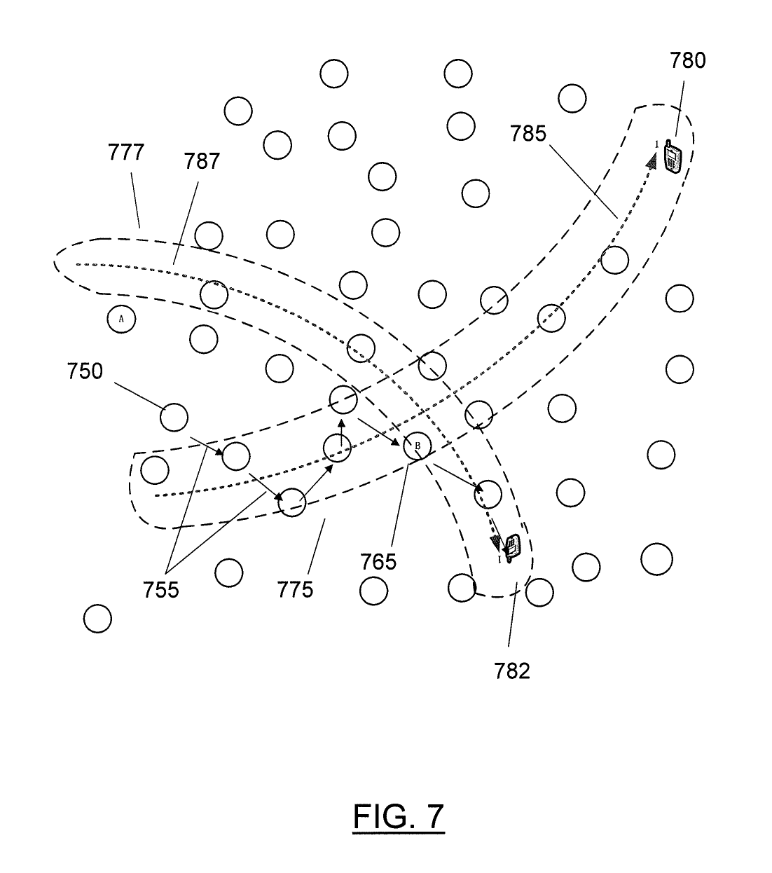

Another exemplary embodiment of the present invention is illustrated in FIG. 7 where two mobile sinks are present within the same wireless sensor network. The path 785 of the first mobile sink 780 generates a trail 775 through the wireless sensor nodes. The path 787 of the second mobile sink 782 generates a second trail 777 through the wireless sensor nodes. As the second mobile sink 782 crossed through the trail 785 of the first mobile sink 780, the sink records of the sensor nodes that witnessed both mobile sinks 765 have their sink record information replaced with the sink information from the second mobile sink 782 since it was the most recent to encounter those sensor nodes. In this instance, a data packet may begin on the trail created by the first mobile sink 780; however the most recent sink records of the trail 777 created by the second mobile sink 782 direct the data packet to the second mobile sink 782 as shown by the path 755.

As noted above, each sensor node may have a routing table to more efficiently forward a data packet. The routing table may be learned by the sensor node and each sensor node may maintain its own routing table, such as in memory device 24 of FIG. 2, for example. The routing table is learned when a sensor node (node x) overhears the transmission of a reply message issued by another node (node y, where y does not equal x). If node x's routing table is empty or the timestamp included in the reply message is more recent than the timestamp in node x's routing table, node x may create or update its routing table with a routing record containing: next-hop information, a timestamp copied from the received reply message, and a timer that specifies the duration of time until the routing record will expire. The next-hop information is the sender of the reply message and since the sender is sending a reply, that sensor node has more accurate information regarding the location or the trail of the sink node. In this embodiment, sensor node x will send data packets to the replying node provided the timer has not yet expired and sensor node x does not have a more recent sink record or routing record. This procedure for routing table learning introduces no extra protocol overhead and may reduce the possibility of triggering a random walk for packet forwarding, therefore shortening the average data transfer delay. For sensor node x, the routing table will contain at most one entry at any time, which records the information for reaching the best sink that sensor x has seen recently. An exemplary embodiment of the logic to create a routing table is illustrated in TABLE 4 below.

TABLE 4
/* The following procedure is triggered when a sensor hears a reply
message issued by another sensor or directly from a sink. */
Procedure RoutingTableCreation(x, y) //x is the receiving sensor, and y is
the sender of reply message.

| | |
|---|---|
| 1. | If y is a sink, then |

| | |
|---|---|
| 2. | x creates a routing table RoutingTable.NextHopID ← y and sets |
| | a timer with this entry. |

| | |
|---|---|
| 3. | else if x's Sink Table is void or the time stamp in the received reply |
| | message is fresher than that stored in x's Sink Table, then |

| | |
|---|---|
| 4. | x creates or updates its routing table |
| | RoutingTable.NextHopID ← y and sets a timer with |

this entry.

end RoutingTableCreation

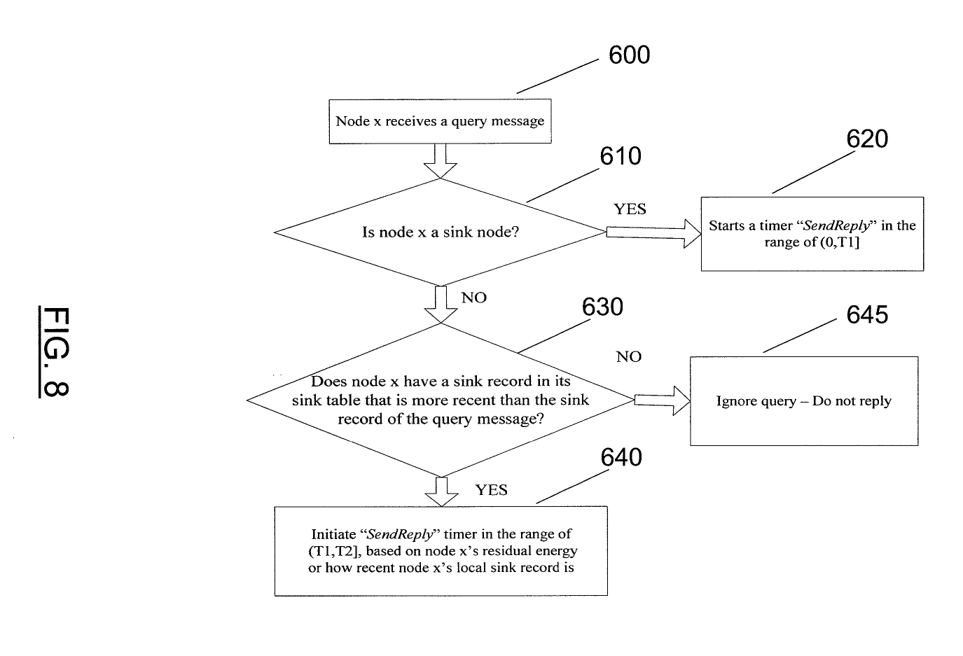

A flowchart illustrating the steps involved when a node receives a query message is illustrated in accordance with one exemplary embodiment in FIG. 8. Node x receives a query message at block 600 through, for example, the communication interface 26 of FIG. 2. If node x is a sink node at block 610, the “SendReply” timer is initiated in the range of [0,T1] at block 620 and may be performed by the processor 22 of FIG. 2. If node x is not a sink node at block 610, the sink table of node x is referenced to determine if there is a more recent sink record at node x in block 630. If there is a more recent sink record at block 630, the “SendReply” timer is initiated in the range of [T1,T2] which is set based on node x's residual energy or how recent node x's local sink record is at block 640. If the sink record of node x is not more recent than the querying node at block 630, no reply is sent from node x and the querying node ignores node x at block 645.

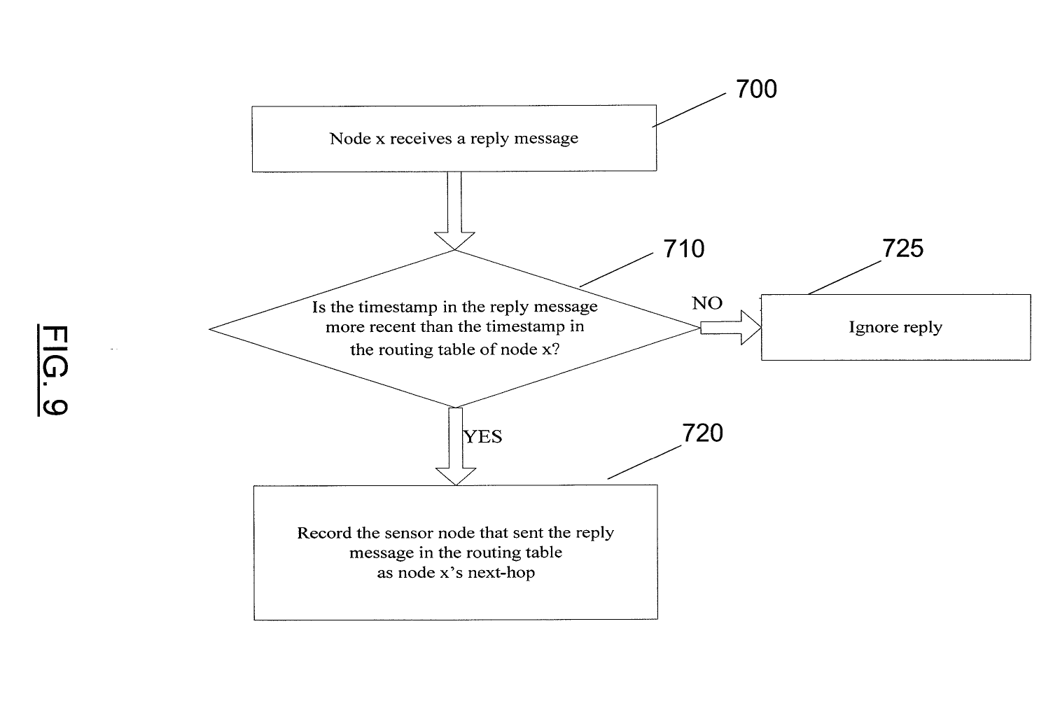

A flowchart illustrating how a node handles a reply message is illustrated in accordance with an exemplary embodiment in FIG. 9. When node x receives a reply message at block 700, the reply message is compared to the routing record of node x at block 710. If the reply message contains a more recent timestamp, then the reply message is entered into node x's routing table as the next-hop information at block 720. The reply message may be received by the communication interface 26 of node x as shown in FIG. 2 and entered into the routing table in the memory device 24 by the processor 22. If the reply message contains an older timestamp than in the routing table of node x at block 710, the reply is ignored at block 725.

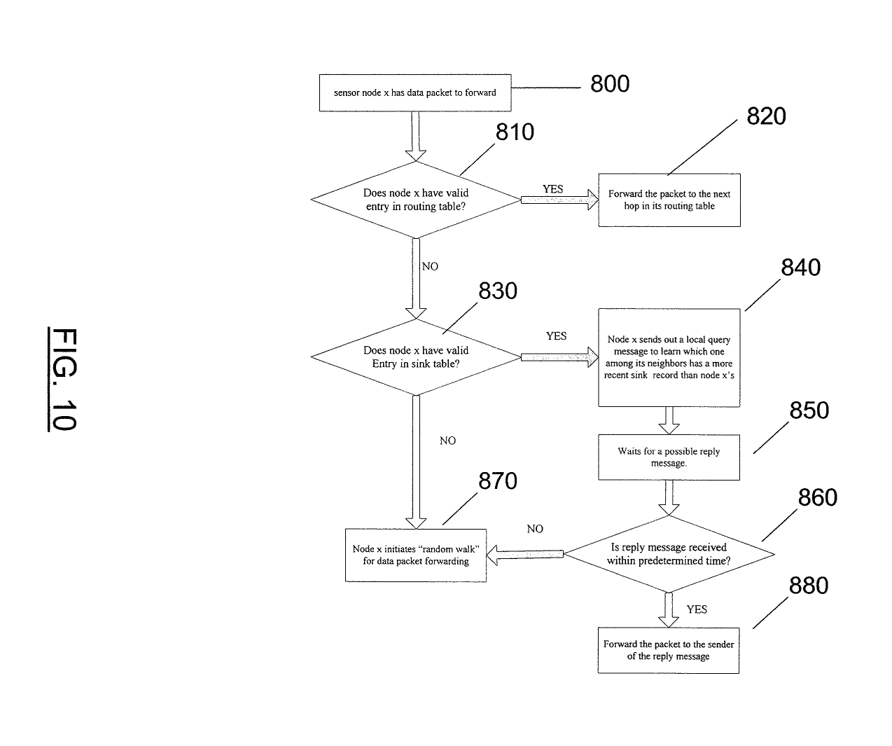

FIG. 10 illustrates a flowchart of an exemplary embodiment of the present invention that uses a routing table and a sink table at a sensor node. At block 800, the sensor node either generates or receives a packet to forward. The sensor node of this embodiment first references the routing table that may be stored in the memory device to determine if there is a valid routing record at block 810. If the node has a valid routing record, the data packet is forwarded to the next hop found in the routing record at block 820. If there is no valid routing record in the routing table at block 810, the node then references the sink table to determine if there is a valid sink record at block 830. If there is a valid sink record, the node will send out a local query message (using the Procedure QueryProcessing of TABLE 2 outlined above) to learn which neighbor has the most recent sink record at block 840. The sensor node will then wait for a reply at block 850. If a reply message is received within a certain period of time at block 860 by the communication device, the data packet is forwarded to the sender of the reply message at block 880. If a reply message is not received within a certain period of time at block 860, the node initiates a random walk for data packet forwarding at block 870 by means of the processor. Similarly, if there is no valid sink record in the sink table at block 830, the node will initiate a random walk for data packet forwarding at block 870.

A method of optimizing the trail-based forwarding of data packets is to broaden the sink trail with traffic-adaptive sink trail broadening. Broadening a sink trail can be helpful in attracting more data packets to travel along the trail instead of resorting to random walk. The width of a sink trail can approximately be represented by the amount of sensors on the trail. More specifically, a sensor is said to be on the trail of a mobile sink if the sensor witnessed the recent visit of the sink in its neighborhood and also locally keeps a valid sink table for this visit.

Traffic-adaptive sink trail broadening allows a sensor, that has ever recently witnessed a sink's passing by, to further notify its direct neighbors about this fact by issuing a hello message. The network load perceived by a sensor node may be estimated by the number of data packet transmissions overheard by the node in the past T seconds, where T is a network parameter. Specifically, the preconditions for a sensor node x to broadcast a hello message to its neighboring nodes may be as follows: (a) the number of data packet transmissions in the past T seconds, overheard by node x, exceeds a certain threshold (e.g., 10 data packet transmissions in 5 seconds), and (b) the number of overheard transmissions of hello messages by the neighboring nodes of node x is below a threshold (e.g., four times). When these preconditions are met, sensor node x may issue a hello message, which contains the following information:
The ID of the hello sender: x;
A timestamp value copied from the sink table of sensor node x;
Timer value copied from the local sink table entry of sensor node x and specifying the remaining time that the entry will still be valid at sensor node x.
   Condition (a) is configured to trigger trail broadening only when the local traffic load is big enough and condition (b) is configured to avoid too many transmissions of hello messages in the vicinity.

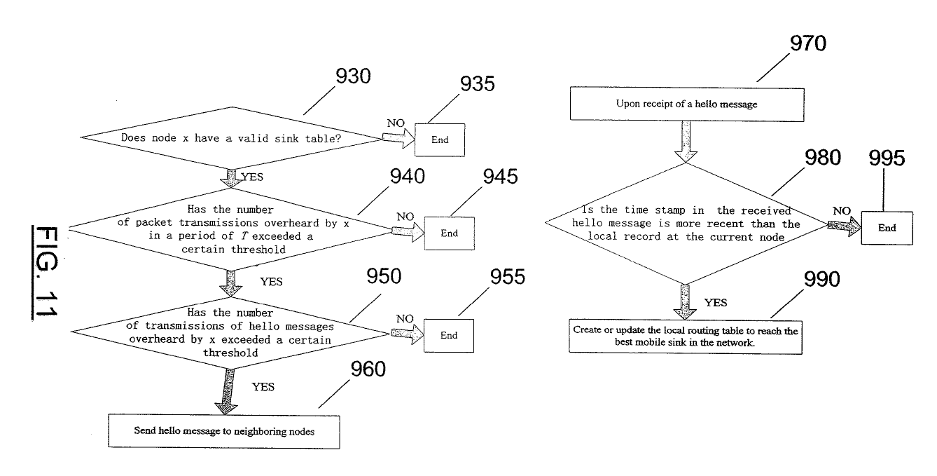

A flowchart illustrating traffic-adaptive trail-broadening in accordance with one exemplary embodiment is illustrated in FIG. 11. A hello message may be generated in this embodiment if node x has a valid sink table at block 930, if the number of packet transmissions overheard by node x in a period of T exceeds a predetermined value at block 940, and if the number of transmissions of hello messages overheard by sensor node x exceeds a predetermined value at block 950, only then will a hello message be sent from node x to its neighboring sensor nodes at block 960. If any of those conditions are not met, the subroutine would end at block 935, 945, or 955. Upon receipt of a hello message by a neighboring node at block 970, the neighboring node may determine if the hello message is more recent than the local record of the neighboring node at block 980. If so, the local routing table of the neighboring node is updated with the information of the hello message at block 990. If not, the subroutine ends at block 995.

Advantages of the traffic-adaptive sink trail broadening may include: enabling certain nodes not hearing the passing-by of a mobile sink to join the sink trail and thus reduce the possibility of generating a random walk; enabling fast routing table learning such that, upon receipt of a hello message with a more recent timestamp, a node can add the sender of the hello message as its next hop for packet forwarding along the sink trail; the method is triggered in a traffic-adaptive manner such that the trail broadening is likely to be useful for packet forwarding; and the trail broadening procedure is also, to some extent, helpful to remedy the case of trail-break when there is a void area (e.g., a hole) along the trail if the hole is not too large.

As described above, FIGS. 8-11 illustrate flowcharts of example systems, methods, and/or computer program products according to example embodiments of the invention. It will be understood that each block or operation of the flowcharts, and/or combinations of blocks or operations in the flowcharts, can be implemented by various means. Means for implementing the blocks or operations of the flowcharts, combinations of the blocks or operations in the flowchart, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as memory devices of an example apparatus, such as the sensor nodes or sinks, and executed by a processor, such as the processor. As will be appreciated, any such program code instructions may be loaded onto a computer or other programmable apparatus (e.g., the processors or memory devices) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Existing strategies for data gathering in wireless sensor networks may be divided into four types: (1) building network-wide delivery structures covering all sensor nodes in the network for timely data reporting, potentially via the shortest paths; (2) using pure random walk such that each packet is forwarded randomly across the network until reaching a sink or is discarded; (3) employing geographical packet forwarding; and (4) using data mules. Embodiments of the present invention use a combination of techniques, such as random walk and trail-based forwarding, for efficient data gathering. Embodiments of the present invention further introduce several optimization techniques for performance improvement. Compared with strategy (1) above, embodiments of the present invention have little or at least reduced amounts of proactive protocol overhead for data gathering thereby reducing traffic on the wireless sensor network. Compared with strategy (2) above, embodiments of the present invention provide a mechanism to largely reduce the length of paths that data packets are forwarded with little extra protocol overhead. Compared with strategy (3) above, embodiments of the present invention do not require sensors for localization equipment and embodiments of the present invention are suitable for a greater number of applications. Compared with strategy (4) above, embodiments of the present invention provide a mechanism with low packet delivery latency whereas packet delivery latency with data mule can potentially take hours or days.

Embodiments of the present invention are relatively simple with low protocol overhead for network management and data reporting, in particular when the traffic load in the network is light or medium. Embodiments of the present invention may be fully localized in nature and lightweight (e.g., the amount of codes for the mechanism to work is small). Embodiments of the present invention may also require little storage overhead because the sensors only need to store information about the last witnessed mobile sink.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

That which is claimed:

1. A method comprising:
determining whether next-hop information is available regarding a mobile sink to which a prior message intended for receipt by a mobile sink was directed;
providing for transmission of a current message based upon the next-hop information in instances in which the next-hop information is available;
determining whether timestamp information is available regarding prior receipt of a beacon message from a mobile sink; and
providing for transmission of the current message based on the timestamp information in instances in which the timestamp information is available.

2. A method according to claim 1, further comprising:
determining whether neighboring network nodes have timestamp information available regarding prior receipt of a beacon message from a mobile sink; and
providing for transmission of the current message based on the most recent timestamp information where more than one network node possesses timestamp information.

3. A method according to claim 1 or 2, further comprising receiving a beacon message from a mobile sink wherein the beacon message includes timestamp information and mobile sink identification information.

4. A method according to claim 3, further comprising generating a table to include the timestamp information and mobile sink identification information contained in the beacon message.

5. A method according to claim 4, further comprising receiving a signal from a neighboring sensor node and replacing the information contained in the table with the information contained in the signal from the neighboring sensor node in instances in which the timestamp information from the neighboring sensor node is more recent than the timestamp information contained within the table.

6. A method according to claim 4, further comprising initiating a timer upon receipt of the beacon message wherein the timestamp information and mobile sink identification information are removed from the table upon expiration of the timer.

7. A method according to claim 1 or 2, further comprising initiating a random walk in instances in which no timestamp information is available.

8. An apparatus comprising:
at least one processor; and
at least one memory including computer program code, the at least one memory and the computer program code configured to, with the at least one processor, cause the apparatus at least to perform:
determine whether next-hop information is available regarding a mobile sink to which a prior message intended for receipt by a mobile sink was directed;
provide for transmission of a current message based upon the next-hop information in instances in which the next-hop information is available;
determine whether timestamp information is available regarding prior receipt of a beacon message from a mobile sink; and
provide for transmission of the current message based on the timestamp information in instances in which the timestamp information is available.

9. An apparatus according to claim 8, wherein the at least one memory and the computer program code are configured to, with the at least one processor, cause the apparatus to:
determine whether neighboring network nodes have timestamp information available regarding prior receipt of a beacon message from a mobile sink; and
provide for transmission of the current message based on the most recent timestamp information where more than one network node possesses timestamp information.

10. An apparatus according to claim 8 or 9, wherein the at least one memory and the computer program code are configured to, with the at least one processor, cause the apparatus to receive a beacon message from a mobile sink wherein the beacon message includes timestamp information and mobile sink identification information.

11. An apparatus according to claim 10, wherein the at least one memory and the computer program code are configured to, with the at least one processor, cause the apparatus to generate a table to include the timestamp information and mobile sink identification information contained in the beacon message.

12. An apparatus according to claim 11, wherein the at least one memory and the computer program code are configured to, with the at least one processor, cause the apparatus to receive a signal from a neighboring sensor node and replacing the information contained in the table with the information contained in the signal from the neighboring sensor node in instances in which the timestamp information from the neighboring sensor node is more recent than the timestamp information contained within the table.

13. An apparatus according to claim 11, wherein the at least one memory and the computer program code are configured to, with the at least one processor, cause the apparatus to initiate a timer upon receipt of the beacon message wherein the timestamp information and mobile sink identification information are removed from the table upon expiration of the timer.

14. An apparatus according to claim 8 or 9, wherein the at least one memory and the computer program code are configured to, with the at least one processor, cause the apparatus to initiate a random walk in instances in which no timestamp information is available.

15. A computer program product comprising at least one computer-readable storage medium having computer-readable program instructions stored therein, the computer-readable program instructions configured to cause an apparatus at least to perform:
determine whether next-hop information is available regarding a mobile sink to which a prior message intended for receipt by a mobile sink was directed;
provide for transmission of a current message based upon the next-hop information in instances in which the next-hop information is available;
determine whether timestamp information is available regarding prior receipt of a beacon message from a mobile sink; and
provide for transmission of the current message based on the timestamp information in instances in which the timestamp information is available.

16. A computer program product according to claim 15, wherein the computer-readable program instructions are further configured to cause the apparatus to:
determine whether neighboring network nodes have timestamp information available regarding prior receipt of a beacon message from a mobile sink; and
provide for transmission of the current message based on the most recent timestamp information where more than one network node possesses timestamp information.

17. A computer program product according to claim 15 or 16, wherein the computer-readable program instructions are further configured to cause the apparatus to receive a beacon message from a mobile sink wherein the beacon message includes timestamp information and mobile sink identification information.

18. A computer program product according to claim 17, wherein the computer-readable program instructions are further configured to cause the apparatus to generate a table to include the timestamp information and mobile sink identification information contained in the beacon message.

19. A computer program product according to claim 18, wherein the computer-readable program instructions are further configured to cause the apparatus to receive a signal from a neighboring sensor node and replacing the information contained in the table with the information contained in the signal from the neighboring sensor node in instances in which the timestamp information from the neighboring sensor node is more recent than the timestamp information contained within the table.

20. A computer program product according to claim 18, wherein the computer-readable program instructions are further configured to cause the apparatus to initiate a timer upon receipt of the beacon message wherein the timestamp information and mobile sink identification information are removed from the table upon expiration of the timer.

21. A computer program product according to claim 15 or 16, wherein the computer-readable program instructions are further configured to cause the apparatus to initiate a random walk in instances in which no timestamp information is available.
